(19) United States
(12) Patent Application Publication
(10) Pub. No.: US 2016/0125516 A1
(43) Pub. Date: May 5, 2016

(54) METHOD AND DEVICE FOR DISPLAYING INFORMATION

(71) Applicant: Xiaomi Inc., Beijing (CN)

(72) Inventors: Qiang Fu, Beijing (CN); Yang Wang, Beijing (CN); Qiao Ren, Beijing (CN); Ming Zhao, Beijing (CN)

(73) Assignee: XIAOMI INC., Beijing (CN)

(21) Appl. No.: 14/732,020

(22) Filed: Jun. 5, 2015

Related U.S. Application Data
(63) Continuation of application No. PCT/CN2015/075026, filed on Mar. 25, 2015.

(30) Foreign Application Priority Data
Oct. 29, 2014 (CN) 201410592403.X

(51) Int. Cl. G06Q 30/06; G06Q 10/00; G06F 3/0484

(52) U.S. Cl. CPC G06Q 30/0641; G06F 3/0484; G06Q 10/20

(57) ABSTRACT

A method and a device for displaying apparatus information is described. A terminal may be used to control an apparatus, such as a household appliance. The terminal may receive a request for displaying apparatus control interface. The terminal may acquire information of the apparatus; and generate a store interface according to the apparatus information. The store interface may facilitate a user to receive information of a product corresponding to the apparatus and purchase the product conveniently, accurately, and quickly. The terminal may, thus, improve the user experience, and save time, costs, and network resources.

### CROSS-REFERENCE TO RELATED APPLICATIONS

This application is a Continuation Application of International Application PCT/CN2015/075026, with an international filing date of Mar. 25, 2015, which is based upon and claims priority to Chinese Patent Application No. 201410592403.X, filed Oct. 29, 2014, the entire contents of which are incorporated herein by reference.

### TECHNICAL FIELD

The present document relates to the field of displaying information about an apparatus, and more particularly, to a method and a device for displaying information.

### BACKGROUND

With the development of smart home technologies and wireless network technologies, household appliances such as an air purifier, a water purifier, or any other appliance may possess a remote control function. The household appliance may have an accessory that is suggested to be periodically replaced. For example, a purifier may have a filter element or a filter screen that is to be replaced periodically. When the accessory is to be replaced, a user usually may have to purchase the accessory at a special store, which may be very inconvenient.

### SUMMARY

The present document provides a method and a device for displaying information associated with one or more appliances. The information may be displayed in a uniform and centralized manner so that a user may access and interact with the one or more appliances from a single interface. The present document also describes examples in which an appliance may first be detected and the information associated with the appliance may subsequently be obtained, or acquired.

According to a first aspect a method for displaying apparatus information is provided. The method may include receiving, by a terminal, a request for displaying an apparatus control interface. The method also includes acquiring, by the terminal, apparatus information of an apparatus controlled via the apparatus control interface. The method also includes generating, by the terminal, a store interface according to the apparatus information. The method also includes displaying the store interface, where the store interface includes interaction controls to purchase a product corresponding to the apparatus.

According to a second aspect a device for displaying appliance information is provided. The device may include: a processor. The device may also include a memory for storing instructions executable by the processor. The processor is configured to acquire information of an appliance. The processor is configured to generate a store interface according to the information of the appliance, the store interface including purchase information of an accessory of the appliance.

According to a third aspect, a non-transitory computer readable storage medium having stored therein instructions that, when executed by a processor of a device, causes the device to perform a method for displaying apparatus store information. The non-transitory computer readable storage medium includes instructions to receive a request for displaying an apparatus control interface, where the apparatus control interface facilitates control of an apparatus. The non-transitory computer readable storage medium also includes instructions to receive status information of the apparatus. The non-transitory computer readable storage medium also includes instructions to generate a store interface according to the status information. The non-transitory computer readable storage medium also includes instructions to display the store interface.

The technical solutions provided by the examples described in the present document may facilitate a user to receive information about a product, such as a product associated with an appliance. The user may be informed to purchase the product for the appliance to continue to operate. Alternatively or in addition, the described examples may facilitate the user to purchase the product conveniently, accurately, and quickly. Thus, the user experience may be improved, and time, cost, and network resources may be used more efficiently.

It is to be understood that both the foregoing general description and the following detailed description are exemplary and explanatory only and are not restrictive.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 is a flowchart of an example method for displaying information.

FIG. 2 is a flowchart of an example method for displaying information.

FIG. 3 is a schematic diagram illustrating an example terminal interface.

FIG. 4 is a schematic diagram illustrating an example terminal interface.

FIG. 5 is a block diagram of an example device for displaying information.

FIG. 6 is a block diagram of an example device for displaying information.

FIG. 7 is a block diagram of an example device for displaying information.

### DETAILED DESCRIPTION

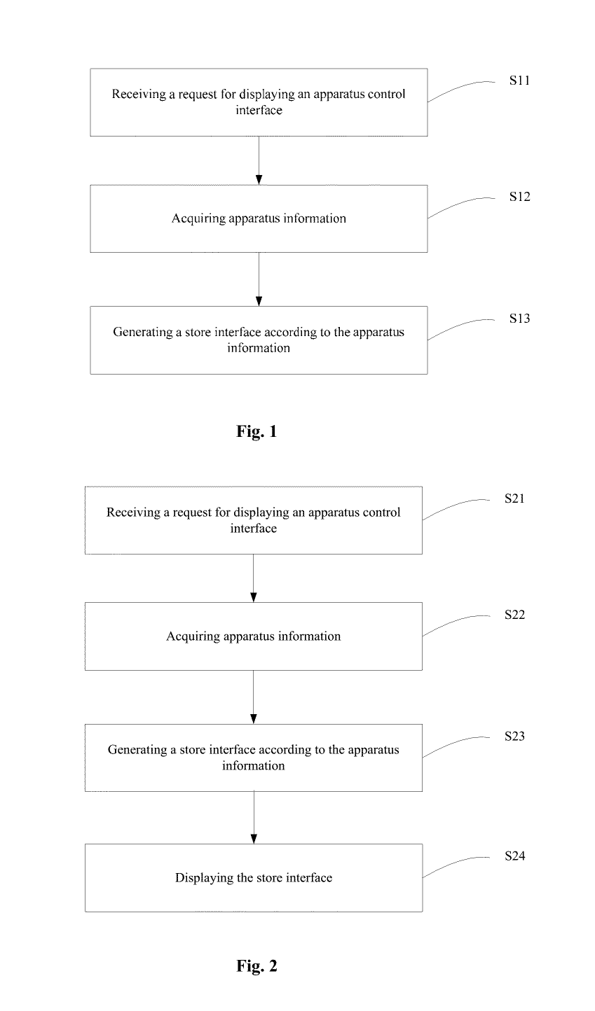

FIG. 1 is a flowchart of an example method for displaying information. The method for displaying information may be implemented or performed by a terminal. The method may include at least the following steps.

In step S11, a request for displaying an apparatus control interface may be received.

For example, a user may control an apparatus, such as an appliance at home via a terminal. The terminal may be a mobile phone or a tablet and the like. The apparatus may be a household appliance. For example, the apparatus may be, but not limited to an air purifier, a water purifier, a TV, an air conditioner, a water dispenser, a sweeping robot, a refrigerator, a thermostat, an electrical socket, an entrance guard, a doorbell, a camera, a router or any other appliance. The household appliance may be a smart household appliance. For example, the user may configure the operation of the smart household appliance according to his/her preferences and/or schedule.

In an example, the user may configure the apparatus via the terminal. The user may configure the terminal to control multiple apparatus, such as multiple household appliances at the user's home, or office, or any other location or a combination thereof. In an example, the user may install a single software to control the multiple household appliances. Alternatively, or in addition, the user may install individual software for each respective household appliance. In either case, when the user initiates, or launches the software on the terminal, the terminal may receive a request for displaying an apparatus interface. For example, the apparatus interface may be a control interface for a corresponding apparatus or the multiple apparatus.

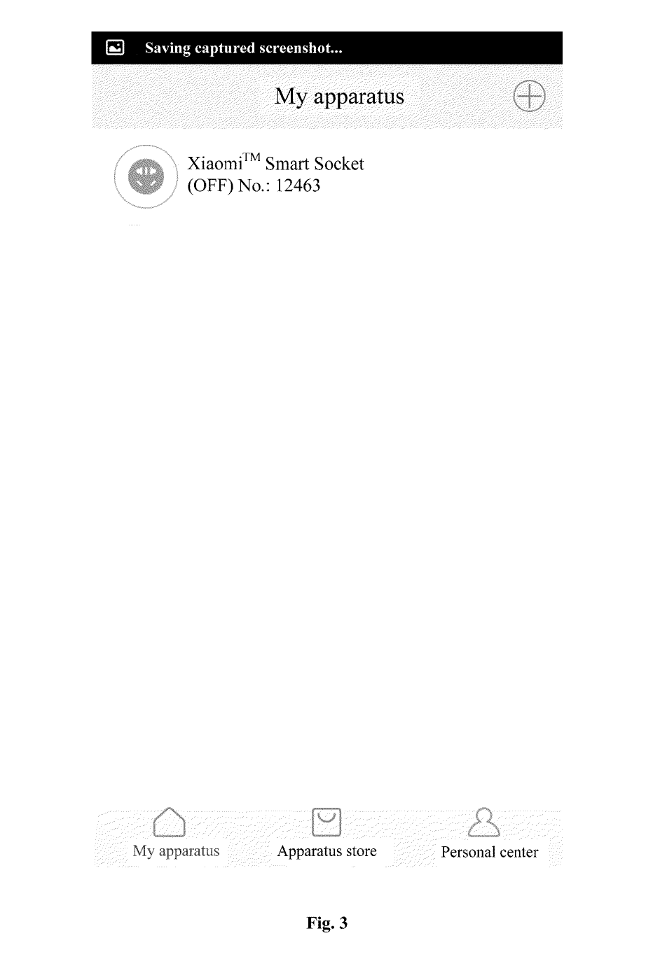

FIG. 3 is a schematic diagram illustrating an example apparatus interface. FIG. 3 illustrates a “My apparatus” interface that is controlling an apparatus such as a Xiaomi™ smart socket. When controlling the apparatus, the user may input an apparatus control command. In response, the terminal may receive the request for displaying the apparatus interface, and in response may display a control interface of the apparatus.

In step S12, the terminal may receive apparatus information.

For example, upon receiving the request for displaying the apparatus interface, the terminal may acquire apparatus information of apparatuses in an apparatus list. Alternatively or in addition, the terminal may acquire apparatus information of the apparatus that is currently operated by the user. The apparatus information may include a current operating status, operating parameters, accessory parameters, service life of accessories and the like, associated with the apparatus.

In step S13, a store interface may be generated according to the apparatus information.

For example, the terminal may identify corresponding product information according to the apparatus information acquired. The terminal may generate the store interface based on the identified product information. In an example, the terminal may identify the product information by conducting an online search. For example, the terminal may determine one or more keywords associated with the products and/or the apparatus information acquired. The terminal may conduct a search for a particular manufacturer or a particular store. For example, the terminal may search for product information in a database, or a website of a manufacturer of the apparatus. The terminal may identify predetermined conditions associated with the product, such as a recommended duration after which the product needs to be replaced, or a recommended operating conditions, such as temperature, current, voltage, or other physical condition or attribute.

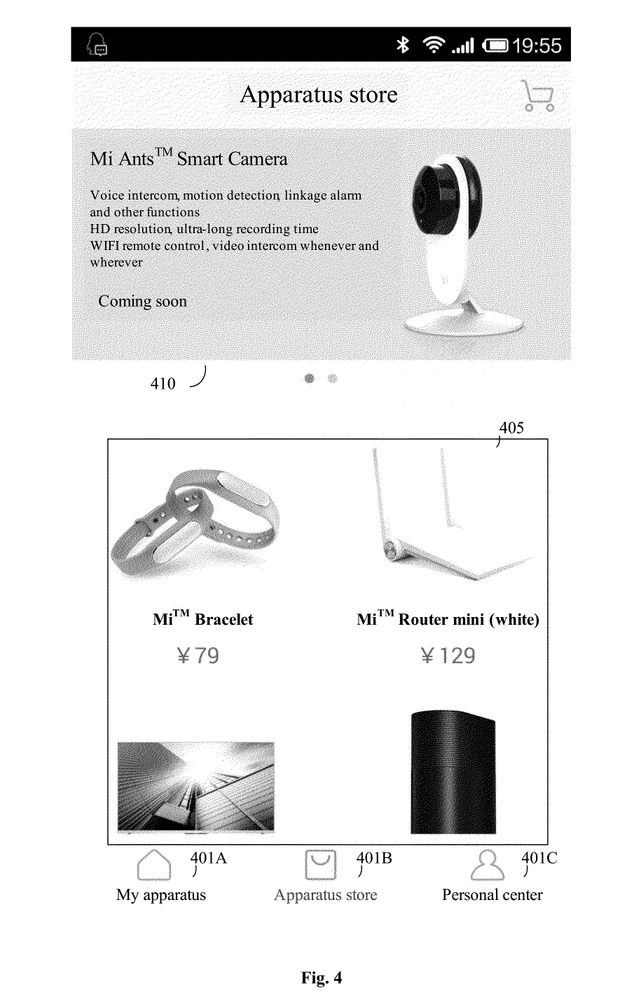

FIG. 4 is a schematic diagram illustrating an example apparatus interface. As shown in FIG. 4, the apparatus interface may include multiple interaction controls, or user input controls such as “My apparatus” 401A, “Apparatus store” 401B, and “Personal center” 401C. In response to a user interaction with each of the interaction controls 401-401C the apparatus interface may display a corresponding user interface screen. For example, interacting with the My Apparatus 401A interaction control may display to a screen, such as in FIG. 3, that displays a list of all the apparatus that may be interacted with via the apparatus interface. Interacting with the Apparatus Store user interaction control 401B may display a store interface 405 that provides product information. The product information may be based on the apparatus information acquired in Step S12.

For example, the terminal may control an air purifier via a corresponding apparatus interface. The air purifier may use accessories such as a filter. The terminal, when acquiring information of the air purifier, may detect that the filter needs to be replaced. For example, the terminal may access information such as the date the filter was previously replaced, or a number of hours the filter has been used, or other attributes associated with the filter. The terminal may determine that the filter has reached end of the service life based on predetermined information such as, a manufacturer's recommended time duration to use the filter, or other such information. Upon the detection, the terminal may display product information of the filter in the store interface 405. Alternatively or in addition, the terminal may control a water purifier. For example, the terminal may detect that a filter screen of the water purifier is damaged. In response, the store interface 405 may display product information of the filter screen.

Alternatively or in addition, the terminal may detect that a new type of accessory or a matched product for an apparatus has been newly released or available for sale. A matching product may be a companion product that may enhance the functionality of the apparatus that is currently being used by the user of the terminal. Alternatively or in addition, the companion product may be a product that may be enhanced by the existing apparatus. For example, a wireless router may be a companion product of a modem that the user may already be using. In another case, if the user currently operates a smart vacuum cleaner, a companion product may be a smart mopping device that may be used subsequently. The terminal may identify the accessory or the companion product based on an alert pushed to the terminal. For example, the alert may be pushed by a store, a manufacturer, a third party service provider, or any other source. In another example, the terminal may identify the accessory or the companion product based on an online search. For example, the terminal may conduct a search in a database of a store, a manufacturer, a third-party service provider, or any other source.

In response to identification of the accessory or companion product, the store interface 405 may be populated with corresponding information of the accessory or the product. Alternatively or in addition, the product information of the new product or accessory may be displayed in a separate section 410 of the store interface. For example, the store interface 405 may identify a product as a newly released product if the product was released within a predetermined duration, such as a week, a month, six months, or any other time limit.

FIG. 2 is a flow chart of an example method for displaying information for an apparatus. The method may be implemented in a terminal, and may include at least the following steps.

In step S21, a request for displaying an apparatus control interface may be received.

In step S22, apparatus information may be acquired.

In step S23, the store interface 405 may be generated according to the apparatus information.

In step S24, the store interface 405 may be displayed.

In an example, when generating the store interface 405, the terminal may not display the store interface 405 instantly, but display the store interface 405 after the user clicks the user interaction control 401B of the “Apparatus store.” Alternatively, the terminal may display the store interface 405 without interaction with the user interaction control 401B. For example, when a new accessory is released or an accessory of an apparatus needs to be replaced urgently, the terminal may display the store interface 405 automatically, without interaction with the interaction control 401B.

Thus, a user of the terminal may be presented with information on products and/or accessories of an apparatus. The terminal may further facilitate a purchase of the products and/or accessories conveniently, accurately, and quickly. Accordingly, user experience for maintaining apparatus, such as a household appliance may be improved, and time, cost, and network resources may be saved.

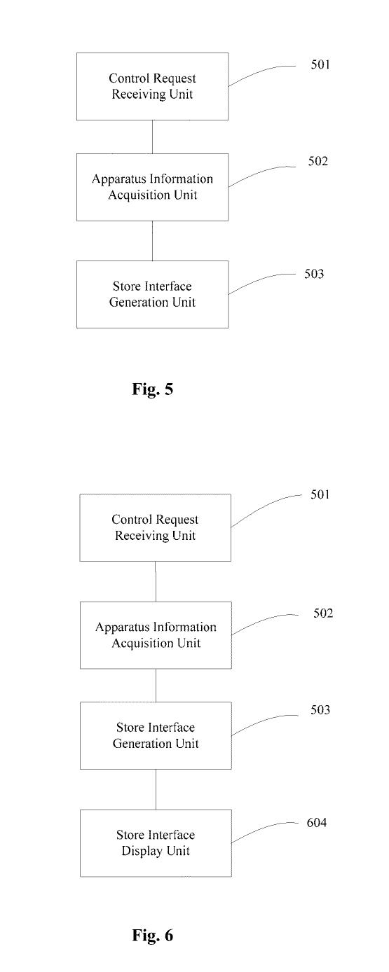

FIG. 5 is a block diagram of an example device for displaying apparatus information. The device may include a control request receiving unit 501, an apparatus information acquisition unit 502, and a store interface generation unit 503.

The control request receiving unit 501 may receive the request for displaying the apparatus control interface.

The apparatus information acquisition unit 502 may acquire apparatus information.

The store interface generation unit 503 may generate the store interface 405 according to the apparatus information.

The control request receiving unit 501 may receive an apparatus control command input by a user of the device. The apparatus control command may be to control the apparatus and may be input via an apparatus control application. Alternatively or in addition, the control request receiving unit 501 may receive a command input by the user for enabling or initiating the apparatus control application.

The apparatus information acquisition unit 502 may acquire information of an apparatus. The apparatus may be one that is currently being operated by the user of the device. Alternatively or in addition, the apparatus information acquisition unit 502 may acquire information of multiple apparatuses that are operable by the user. In an example, the apparatus information acquisition unit 502 may automatically detect the apparatuses that are in proximity to the device. For example, the apparatus information acquisition unit 502 may detect an apparatus that is within a signal range from the device. Upon detection of the apparatus, the apparatus information acquisition unit 502 may acquire apparatus information of the detected apparatus. In another example, the user may identify the apparatus to the device, for example by entering an identifier, or by scanning a barcode, or other steps or a combination thereof.

The store interface generation unit 503 may acquire product information corresponding to the apparatus according to the apparatus information. The store interface generation unit 503 may generate the store interface 405 according to the product information. The product information may include information associated with accessories or other products associated with the apparatus. For example, if one of the apparatus detected by the device is a modem, the device may identify products on the market that may be associated with the modem, such as a router. The device may identify a product that is sold by a predetermined store, or is manufactured by a predetermined manufacturer, or that satisfies any other such condition or a combination thereof. The store interface generation unit 503 may generate the store interface 405 and add the product information about the router into the store interface 405. The generated store interface 405 may then be displayed to the user.

The device, using the modules, may implement the example methods described in the present document by performing corresponding operations.

FIG. 6 is a block diagram of an example device for displaying apparatus and product information The device may include the control request receiving unit 501, the apparatus information acquisition unit 502, the store interface generation unit 503, and a store interface display unit 604.

The store interface display unit 604 may display the store interface 405.

In an example, the terminal may register an apparatus that is operable by the terminal. For example, the terminal may be used to control all smart appliances within a premises. Alternatively, the terminal may be used to control a subset of smart appliances within the premises. Accordingly, the smart appliances that the terminal is configured to control may be registered with the terminal. For example, the terminal may scan the premises to identify available smart appliances that are controllable by the terminal. In an example, the terminal may scan for the smart appliances based on a predetermined communication protocol, such as Bluetooth, Ethernet, or any other communication protocol. The scan may be performed wirelessly. The terminal may provide the user a list of the identified smart appliances to choose which ones the terminal should operate. In another example, the terminal may provide the user an interface to manually register a smart appliance, such as by entering an identifier, such as a serial number, a MAC address, an IP address, or a Bluetooth code, associated with the smart appliance. Accordingly, the terminal during operation may obtain information from only those smart appliances that are registered with the terminal, or that the terminal is configured to operate, which may improve efficiency and speed of operation of the terminal.

In another example, the smart appliance may trigger the terminal in response to a predetermined event. For example, the smart appliance may identify that an accessory, such as a filter, if up for replacement. The smart appliance may make such a determination by recording when the accessory was previously replaced and based on a predetermined criteria, such as a recommended replacement schedule for the accessory. In response to the determination, the smart appliance may send a request to the terminal to initiate a purchase of the accessory. Thus, efficiency of the operation of the terminal may be further improved as the terminal may not have to acquire information from the smart appliances, in this case. In an example, the smart appliance may trigger a notification for the user via the terminal. In response to the user interacting with the notification, the terminal may generate and display the store interface for purchase of the accessory that is to be replaced.

In another example, the terminal may receive a notification from a remote server in response to which, the terminal may generate and display the store interface for purchase of the accessory. For example, the remote server may be a server operated by or on behalf of the store or the manufacturer of the accessory. In this case, the remote server may contain or have access to information about a schedule for replacement of the accessory. For example, the accessory, previously, may have been bought via the terminal from the store or from the manufacturer. After a predetermined duration of time, such as that recommended for replacement of the accessory, the remote server may send a notification to the terminal. In response to the user interacting with the notification, the terminal may generate and display the store interface. Alternatively or in addition, the terminal may generate the store interface in response to receipt of the notification from the remote server. In an example, the notification from the remote server may include special offers such as coupons, new releases, rebates, or other offers from the store or the manufacturer.

The notification from the smart appliance or the remote server may trigger a request to display the control interface.

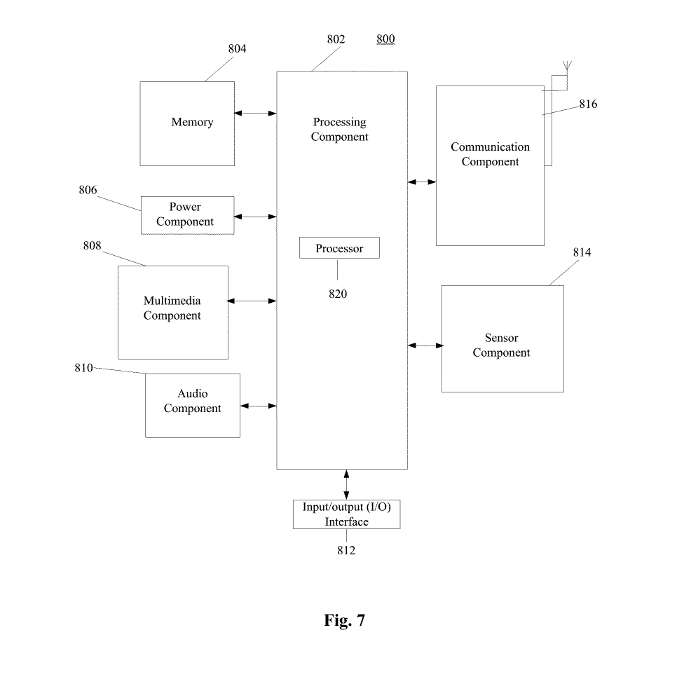

FIG. 7 is a block diagram of an example device 800 for displaying apparatus and product information. For example, the device 800 may be a mobile phone, a computer, a digital broadcast terminal, a messaging device, a gaming console, a tablet, a medical device, exercise equipment, a personal digital assistant, and the like.

Referring to FIG. 7, the device 800 may include one or more of the following components: a processing component 802, a memory 804, a power component 806, a multimedia component 808, an audio component 810, an input/output (I/O) interface 812, a sensor component 814, and a communication component 816.

The processing component 802 may control overall operations of the device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 may store various types of data to support the operation of the device 800. Examples of such data include instructions for any applications or methods operated on the device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 may provide power to various components of the device 800. The power component 806 may include a power management system, one or more power sources, and any other components associated with the generation, management, and distribution of power in the device 800.

The multimedia component 808 may include a screen providing an output interface between the device 800 and the user, such as the store interface display unit 604. The screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and/or the rear camera may receive an external multimedia datum while the device 800 is in an operation mode, such as a photographing mode or a video mode. Each of the front camera and the rear camera may be a fixed optical lens system or have focus and optical zoom capability.

The audio component 810 may output and/or input audio signals. For example, the audio component 810 includes a microphone (“MIC”) configured to receive an external audio signal when the device 800 is in an operation mode, such as a call mode, a recording mode, and a voice recognition mode. The received audio signal may be further stored in the memory 804 or transmitted via the communication component 816. The audio component 810 may include a speaker to output audio signals.

The I/O interface 812 may provide an interface between the processing component 802 and peripheral interface modules, such as a keyboard, a click wheel, buttons, and the like. The buttons may include, but are not limited to, a home button, a volume button, a starting button, and a locking button.

The sensor component 814 may include one or more sensors to provide status assessments of various aspects of the device. For instance, the sensor component 814 may detect an open/closed status of the device 800, relative positioning of components, e.g., the display and the keypad, of the device 800, a change in position of the device 800 or a component of the device 800, a presence or absence of user contact with the device 800, an orientation or an acceleration/deceleration of the device 800, and a change in temperature of the device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 may facilitate communication, wired or wirelessly, between the device 800 and other devices. The device 800 can access a wireless network based on a communication standard, such as WiFi, 2G, or 3G, or a combination thereof. The communication component 816 receives a broadcast signal or broadcast associated information from an external broadcast management system via a broadcast channel. The communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

The device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In an example, a non-transitory computer readable storage medium may include instructions, such as included in the memory 804, executable by the processor 820 in the device 800, for performing the above-described methods. For example, the non-transitory computer-readable storage medium may be a ROM, a RAM, a CD-ROM, a magnetic tape, a floppy disc, an optical data storage device, and the like.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are to be construed in the broadest sense, superseding any other implied definitions hereinbefore or hereinafter unless expressly asserted to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A method for displaying apparatus information, the method comprising:
receiving, by a terminal, a request for displaying an apparatus control interface;
acquiring, by the terminal, apparatus information of an apparatus controlled via the apparatus control interface;
generating, by the terminal, a store interface according to the acquired apparatus information; and
displaying the store interface, wherein the store interface comprises interactive controls to purchase a product corresponding to the apparatus.

2. The method for displaying information according to claim 1, wherein, receiving the request for displaying the apparatus control interface comprises:
receiving an apparatus control command to control the apparatus; or
receiving a command for launching an apparatus control application that facilitates control of the apparatus.

3. The method for displaying information according to claim 1, wherein, acquiring the apparatus information comprises:
acquiring information of the apparatus that is currently being operated via the terminal; or
acquiring information of all apparatuses that are registered with the terminal.

4. The method for displaying information according to claim 1, wherein, generating the store interface according to the apparatus information comprises:
identifying, by the terminal, the product corresponding to the apparatus, wherein the product is an accessory of the apparatus;
acquiring, by the terminal, information associated with the product corresponding to the apparatus; and
adding the product information to the store interface.

5. The method for displaying information according to claim 1, further comprising:
identifying, by the terminal, the product corresponding to the apparatus, based on the product being a companion product of the apparatus, and the product being released within a predetermined duration.

6. The method for displaying information according to claim 1, wherein receiving the request for displaying the apparatus control interface comprises receiving a notification from the apparatus, the notification indicative of a replacement time of an accessory of the apparatus.

7. The method for displaying information according to claim 1, wherein receiving the request for displaying the apparatus control interface comprises receiving a notification from a remote server associated with a store or manufacturer of an accessory of the apparatus, the notification indicative of a replacement time of the accessory of the apparatus.

8. A device for displaying information, the device comprising:
a processor; and
a memory for storing instructions executable by the processor;
wherein the processor is configured to:
acquire information of an appliance; and
generate a store interface according to the information of the appliance, the store interface comprising purchase information of an accessory of the appliance.

9. The device for displaying information according to claim 8, wherein, the processor is further configured to:
receive an appliance control command; or
receive a command for launching an appliance control application.

10. The device for displaying information according to claim 9, wherein, the appliance is currently being operated by the device, and the processor is further configured to:
acquire information of a second appliance that is operable by the device in response to receipt of the command.

11. The device for displaying information according to claim 8, wherein, the processor is further configured to:
acquire information of the accessory of the appliance based on the information of the appliance; and
generating the store interface based on the information of the accessory.

12. The device for displaying information according to claim 8, the processor is further configured to:
display the store interface on a display unit.

13. A non-transitory computer readable storage medium having stored therein instructions that, when executed by a processor of a device, causes the device to perform a method for displaying an apparatus store interface, wherein the non-transitory computer readable storage medium comprises:
instructions to receive a request for displaying an apparatus control interface, wherein the apparatus control interface facilitates control of an apparatus;
instructions to receive status information of the apparatus;
instructions to generate a store interface according to the status information; and
instructions to display the store interface.

14. The non-transitory computer readable storage medium according to claim 13, wherein, the instructions to receive the request for displaying the apparatus control interface further comprises:
instructions to receive an apparatus control command; or
instructions to receive a command for launching an apparatus control application.

15. The non-transitory computer readable storage medium according to claim 13, wherein, the instructions to receive the status information comprises:
instructions to identify the apparatus currently being operated by the apparatus control interface and to request status information of the identified apparatus; or
instructions to request status information of all apparatuses that are operable by the apparatus control interface.

16. The non-transitory computer readable storage medium according to claim 13, wherein, the instructions to generate the store interface according to the status information further comprises:
instructions to identify a product used by the apparatus based on the apparatus information;
instructions to acquire status information of the product corresponding to the apparatus; and
instructions to generate the store interface according to the status information of the product.

17. The non-transitory computer readable storage medium according to claim 16, wherein, the apparatus is a household appliance and the product is a replaceable accessory of the appliance.

18. The non-transitory computer readable storage medium according to claim 17, wherein the status information of the product is representative of when the accessory was replaced previously.

19. The non-transitory computer readable storage medium according to claim 18, wherein the non-transitory computer readable storage medium further comprises:
instructions to determine whether the accessory is to be replaced based on the status information and a predetermined threshold; and
instructions to add information about the accessory to the store interface.

20. The non-transitory computer readable storage medium according to claim 13, wherein the request to display the apparatus control interface is received from at least one of the apparatus, a remote server associated with a manufacturer or store, wherein said request comprises purchase information of an accessory of the apparatus that is scheduled for replacement.
